(19) United States
(12) Patent Application Publication
(10) Pub. No.: US 2012/0223986 A1
(43) Pub. Date: Sep. 6, 2012

(54) LIQUID EJECTING APPARATUS

(75) Inventors: Yoichi Yamada, Suwa-shi (JP); Masaru Kobashi, Suwa-shi (JP); Toshiya Okada, Suwa-shi (JP)

(73) Assignee: SEIKO EPSON CORPORATION, Shinjuku-ku (JP)

(21) Appl. No.: 13/405,116

(22) Filed: Feb. 24, 2012

(30) Foreign Application Priority Data
Mar. 2, 2011 (JP) 2011-044587

(51) Int. Cl. B41J 29/38

(52) U.S. Cl. 347/10

(57) ABSTRACT

A platen includes a main body, a plurality of support protrusions protruding on the surface of the side opposite a nozzle formation surface when ejection is performed, in the main body, in which a voltage that is applied to the platen is set such that the intensity of an electric field generated between nozzles and an individual driving electrode of a recording head when ink is ejected from the nozzles is in between the intensity of an electric field generated between the nozzle formation surface and the support protrusions and the intensity of an electric field generated between the nozzle formation surface and the main body.

### BACKGROUND

1. Technical Field

The present invention relates to a liquid ejecting apparatus, such as an ink jet type recording apparatus, particularly a liquid ejecting apparatus that ejects liquid in a pressure chamber from nozzles by driving a pressure generating unit.

2. Related Art

A liquid ejecting apparatus is an apparatus equipped with a liquid ejecting head and ejecting various kinds of liquid from the ejecting head. For example, there are image recording apparatuses, such as an ink jet type printer or an ink jet type plotter, as the liquid ejecting apparatus, and recently, liquid ejecting apparatuses are used for various manufacturing apparatuses, using the feature that it is possible to accurately land a very small amount of ink to a predetermined position. For example, the liquid ejecting apparatus is used for a display manufacturing apparatus that manufactures a color filter, such as a liquid crystal display, an electrode forming apparatus that forms electrodes of an organic EL (Electro Luminescence) display or an FED (Field Emission Display), and a chip manufacturing apparatus that manufactures a biochip (biochemical element). Further, the recording head for the image recording apparatus ejects liquid-state ink and color material ejecting heads for the display manufacturing apparatus eject liquid of R (Red), G (Green), and B (Blue) color materials, respectively. Further, the electrode material ejecting head for the electrode forming apparatus eject an electrode material and the bioorganic material ejecting head for the chip manufacturing apparatus ejects a solution of a bioorganic material.

There is a tendency for the recording head used for the printer or the like to reduce the amount of ink ejected from the nozzles due to the demand for improvement in image quality. The earlier speed of droplets is set to be high to surely land a very small amount of droplets onto a recording medium. Accordingly, the droplets ejected from the nozzle extend during scattering and are separated into main droplets at the front and satellite droplets (sub-droplets) behind the main droplets. Some or all of the satellite droplets rapidly decrease in speed due to viscous resistance of the air and change into mist, failing to reach the recording medium. Accordingly, the satellite droplet changed into dust (ink dust) contaminates the inside of the apparatus and adheres to members that are easily charged, such as the recording head or the electric circuit, thereby causing errors in operation.

It has been attempted to actively attract droplets to a support member (or a platen or a base member) supporting a recording medium during recording and land the droplets onto the recording medium by generating an electric field between a nozzle formation surface of a recording head and the support member while charging the droplets ejected from nozzles, in order to prevent the inconvenience (for example, see JP-A-10-278252 or JP-A-2004-202867).

However, as shown in the schematic view of FIG. 8A, while the ink ejected from a nozzle 64 of a recording head grows toward a recording medium P and a support member 65, negative charges are induced at the front portion (the portion that becomes a main droplet Md) close to the support member 65 by electrostatic induction from the support member 65 that has been positively charged, whereas positive charges are induced at the rear end portion close to the opposite nozzle 64. Further, as shown in FIG. 8B, when ink ejected from a nozzle is, for example, separated into main droplets Md, a first satellite droplet Sd1, and a second satellite droplet (mist) Sd2, the main droplet Md is negatively charged, the second satellite droplet Sd2 is positively charged, and the first satellite droplet Sd1 is not charged. In this case, even if the main droplet Md and the first satellite droplet Sd1 are landed on the recording medium P, the second satellite droplet Sd2 is repelled from the positively-charged support member 65 and changes into dust around the nozzle formation surface of the recording medium. Some of the dust adheres to the nozzle formation surface. When dust adheres to the nozzle formation surface, it is necessary to regularly sweep the nozzle formation surface with a wiping member. Further, the mist that does not adhere to the nozzle formation surface may adhere to other components of the printer which have different polarity from the mist and contaminate them.

Accordingly, a configuration that keeps a positively-charged satellite droplet away from a nozzle formation surface (makes a positively-charged satellite droplet travel onto a recording medium) by disposing an electrode around a nozzle, changing the polarity of the nozzle when ink starts to be ejected from the nozzle, for example, from positive to negative, and changing again the polarity of the electrode from positive at the timing when the ink ejected from the nozzle is separated into main droplets and satellite droplets, has been proposed (for example, see JP-A-2010-214652). Further, a configuration that lands droplets onto a recording medium by ejecting ink from a nozzle with a support member (base member) negatively charged, changing the polarity of the support member into positive, allowing main droplets to be landed onto the recording medium by the inertial force, and attracting satellite droplets or mist to the support member, which is charged with the opposite polarity to that of the satellite droplets or the mist, at the timing when the ink is separated into the main droplets and the satellite droplets, has been proposed (for example, see JP-A-2010-214880).

However, recently, as the driving frequency for ejecting ink becomes higher in the type of printer, the next ink is ejected from the nozzle before the satellite droplets land on the recording medium. Therefore, in the configuration of changing the polarity of the electrode at the timing of ejecting ink or the timing of separating the ink, it is more difficult to surely land the satellite droplets to the recording medium and scattering of the ink is influenced, thereby making the landing unstable.

Further, a configuration that prevents an electric field from being generated between the nozzle formation surface and the support member may be considered to prevent the ink from being charged, but it has been known that the ejected ink is charged even though the ink is ejected from a nozzle in the configuration. That is, for example, as shown in FIG. 9, in the configuration of ejecting ink to the recording medium P from a nozzle 71 by generating a pressure change of ink in a pressure chamber 70 and using the pressure change, by applying driving voltage to a driving electrode 69 of a piezoelectric vibrator 68 of a recording head, when piezoelectric voltage is input to the driving electrode 69 of the piezoelectric vibrator 68, the piezoelectric vibrator 68 and the pressure chamber 70 are insulated, such that negative charges are induced in the ink in the pressure chamber 70 around the piezoelectric vibrator 68 by electrostatic induction. Further, positive charges are induced in the ink around the nozzle 71, opposite the piezoelectric vibrator 68. In a common recording head, a nozzle formation surface 72 is grounded, such that the positive charges of the ink moves to the nozzle formation surface 72, but, as described above, in the configuration of ejecting ink at a higher driving frequency, ink is ejected from the nozzle 71 with positive charges remaining. As a result, the ink ejected from the nozzle 71 is positively charged.

Further, the ink ejected from the nozzle 71 has a tendency to be more positively charged (negative decreases when negatively charged and then ejected) by the Lenard effect while scattered toward the recording medium. That is, when the ink is charged, the positive charges collect to the center portion, while the negative charges collect to the surface portion. Further, the droplets are gradually made positive by vaporization or separation of the surface portion during scattering.

As described above, since the ink ejected from the nozzle is charged even in the configuration that does not generate an electric field between the nozzle formation surface and the support member, mist adheres to the nozzle formation surface or the components of the printer.

The phenomenon described above is not limited to the piezoelectric vibrator and is also generated in other pressure generating units that are operated by applying a driving voltage, such as a heater element.

### SUMMARY

An advantage of some of the aspects of the invention is to provide a liquid ejecting apparatus that can prevent the inside of the apparatus from being contaminated, by controlling charge of droplets ejected from a nozzle.

According to an aspect of the invention, there is provided a liquid ejecting apparatus including: a liquid ejecting head that has a nozzle formation surface where nozzles ejecting liquid are formed and a pressure generating unit driven by a driving signal and generating a pressure change in a liquid in a pressure chamber communicating with the nozzles, and ejects the liquid toward a landing target from the nozzle by driving the pressure generating unit; a driving signal generating unit that generates the driving signal for driving the pressure generating unit; a support unit that is disposed with a gap from the nozzle formation surface of the liquid ejecting head and supports the landing target in ejecting; and an electric field generating unit that generates an electric field between the nozzle formation surface and the support unit by applying a voltage having the same polarity as the polarity of the driving signal to the support unit, in which the support unit has a main body having a surface opposite the nozzle formation surface of the liquid ejecting head when the ejection is performed and a plurality of support portions protruding on the surface, and the applied voltage for the support unit is set such that the intensity of an electric field generated between a driving electrode and the nozzles when the liquid is ejected from the nozzles is in between the intensity of an electric field generated between the nozzle formation surface and the support portions and the intensity of an electric field generated between the nozzle formation surface and the main body.

According to the aspect of the invention, since the applied voltage for the support unit is set such that the intensity of an electric field generated between the driving electrode and the nozzles when liquid is ejected from the nozzles is in between the intensity of an electric field generated between the nozzle formation surface and the support portions and the intensity of an electric field generated between the nozzle formation surface and the main body, the positive charges induced to the liquid around the nozzles by applying a voltage to the driving electrode of the pressure generating unit are offset and the droplets ejected from the nozzles are suppressed from being charged. As described above, even if the droplets are separated while scattering toward the landing target, such as a recording medium, and satellite droplets or mist smaller than the satellite droplets are generated, the mist is suppressed from being charged, by preventing the droplets ejected from the nozzles from being charged as much as possible, such that less mist adheres to the components (such as the driving motor, the driving belt, and the linear scale) in the apparatus. As a result, a breakdown due to the adhering mist is prevented and durability and reliability of the liquid ejecting apparatus are improved.

### BRIEF DESCRIPTION OF THE DRAWINGS

The invention will be described with reference to the accompanying drawings, wherein like numbers reference like elements.

FIG. 1 is perspective view illustrating the configuration of a printer.

FIG. 2 is a cross-sectional view showing the main parts of a recording head.

FIG. 3 is cross-sectional view illustrating the configuration of a piezoelectric vibrator.

FIG. 4 is a block diagram illustrating the electrical configuration of the recording head.

FIG. 5 is a diagram showing a wave form illustrating the configurations of ejection nozzle and a fine vibration nozzle.

FIG. 6 is a schematic view illustrating uncharging of ink when the ink is ejected.

FIGS. 7A and 7B are tables showing the relationship between a platen application voltage and a mist anti-charging effect.

FIGS. 8A and 8B are schematic views illustrating when ink ejected from a nozzle is charged in a configuration where an electric field is generated between the nozzle and a support member.

FIG. 9 is a schematic view illustrating when ink ejected from a nozzle is charged in a configuration where an electric field is not generated between the nozzle and a support member.

### DESCRIPTION OF EXEMPLARY EMBODIMENTS

Embodiments of the invention are described hereafter with reference to the accompanying drawings. Although various limits are applied as detailed examples that are very suitable for the invention in the embodiment described below, the spirit of the invention is not limited thereto, if it is not stated to specifically limit the invention in the following description. Further, an ink jet type of recording apparatus (hereafter, printer) is exemplified below as a liquid ejecting apparatus of the invention.

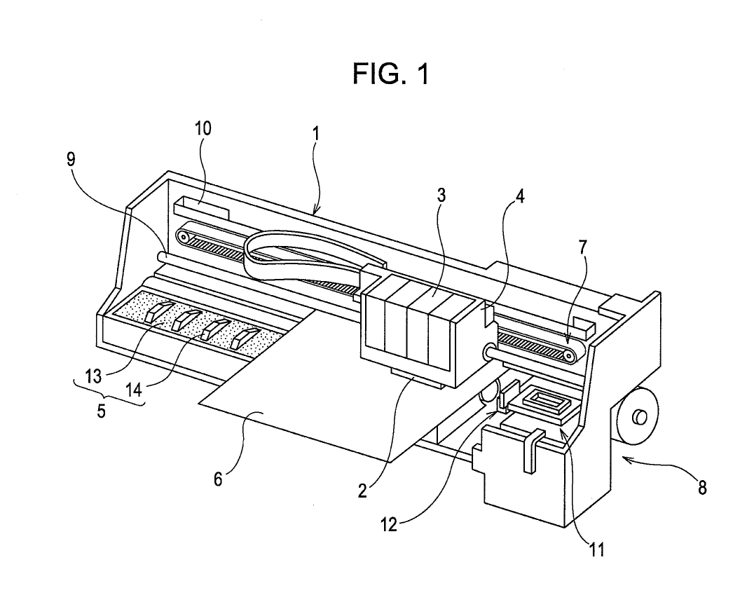

FIG. 1 is a perspective view showing the configuration of a printer 1. The printer 1 includes: a carriage 4 that is equipped with a recording head 2, which is a kind of liquid ejecting head, and detachably equipped with an ink cartridge 3 that is a kind of liquid supplier; a platen 5 that is disposed under the recording head 2 in recording; a carriage moving mechanism 7 that reciprocates the carriage 4 in the width direction of recording paper 6 (a kind of recording medium or a landing target), that is, in the main scanning direction; and a transport mechanism 8 that transports the recording paper 6 in the sub-scanning direction perpendicular to the main scanning direction.

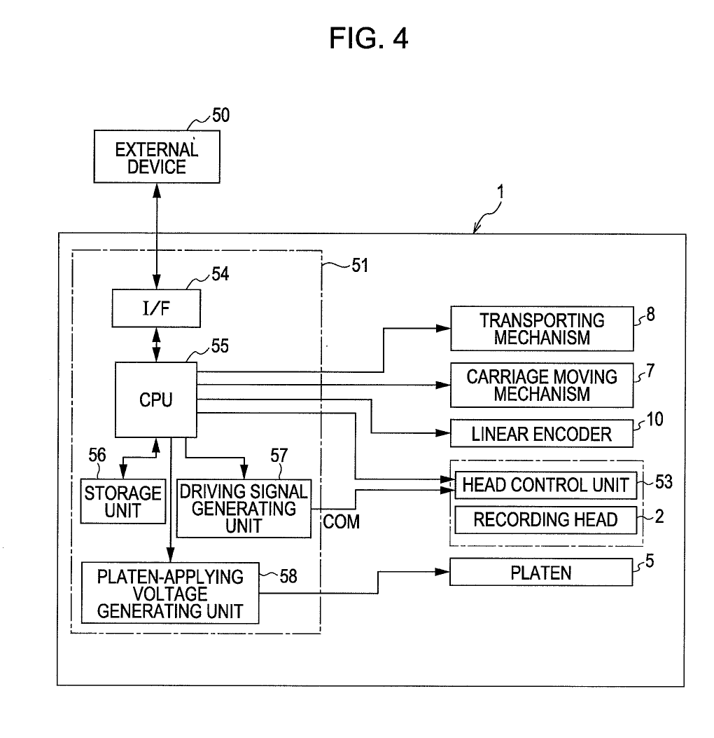

The carriage 4 is fitted on a guide rod 9 held in the main scanning direction to be moved in the main scanning direction along the guide rod 9 through the operation of the carriage moving mechanism 7. The position of the carriage 4 in the main scanning direction is detected by a linear encoder 10 and the detection signal, that is, an encoder pulse (a kind of position information) is transmitted to a printer controller 51 (see FIG. 4). The linear encoder 10, a kind of position information output unit, outputs an encoder pulse EP according to the scanning position of the recording head 2 as position information in the main scanning direction.

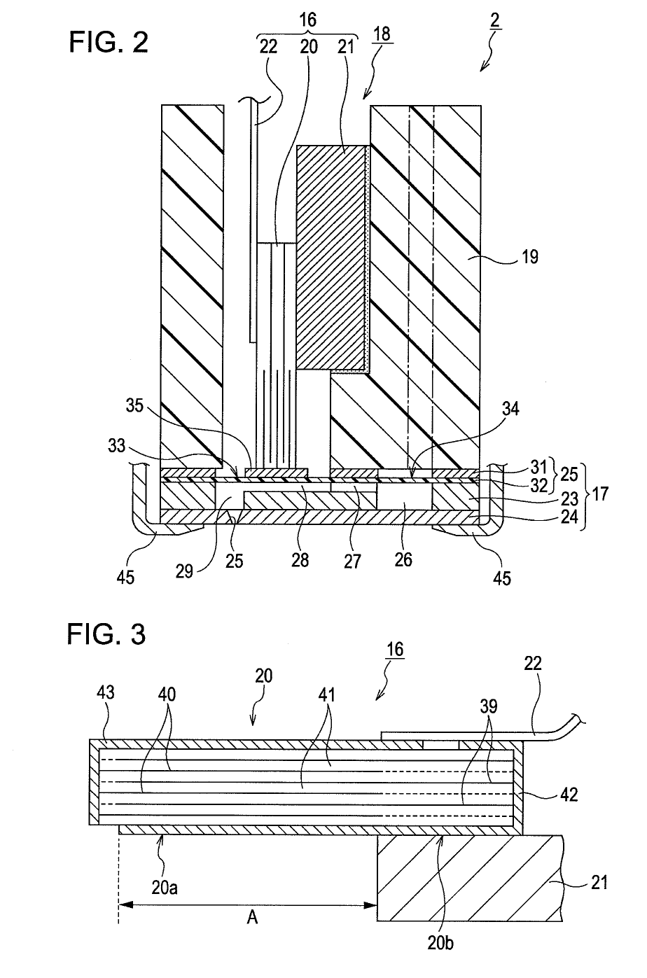

A home position that is the start point of scanning of the carriage is set in an end region outside a recording region within the movement range of the carriage 4. A capping member 11 sealing a nozzle formation surface (nozzle plate 24, see FIG. 2) of the recording head 2 and a wiper member 12 that sweeps the nozzle formation surface are disposed at the home position in the embodiment. Further, the printer 1 can perform so-called bidirectional recording for recording characters or images on the recording paper 6 in both a forward movement when the carriage 4 moves from the home position toward the opposite end and a backward movement when the carriage 4 returns to the home position from the opposite end.

The platen 5 includes a main body 13 having a shape that is long in the main scanning direction and a plurality of support protrusions 14 (corresponding to support portions in the invention) protruding at predetermined intervals longitudinally on the top of the main body 13 (surface opposite a nozzle formation surface of the recording head 2 during recording). The main body 13 in the embodiment is provided with conductivity by adding a conductive material, such as carbon to a material (synthetic resin or the like) of the main body 13. Accordingly, a voltage is applied to the main body 13 from a platen application voltage generating unit 58, which is described below. This is described in detail below. The support protrusions 14 protruding upward from the main body 13 are integrally formed with the main body 13. Accordingly, the tops of the support protrusions 14 are contact surfaces supporting recording paper 6 and partially support the back of the recording paper 6.

FIG. 2 is a cross-sectional view illustrating the main parts in the configuration of the recording head 2. The recording head 2 includes a case 19, a vibrator unit 16 accommodated in the case 19, a channel unit 17 bonded to the bottom (front end surface) of the case 19, and a cover member 45. The case 19 is made of epoxy-based resin and an accommodating space 18 for accommodating the vibrator unit 16 is defined therein. The vibrator unit 16 includes a piezoelectric vibrator 20 that functions as a kind of pressure generating unit, a fixing plate 21 where the piezoelectric vibrator 20 is bonded, and a flexible cable 22 for supplying a driving signal to the piezoelectric vibrator 20.

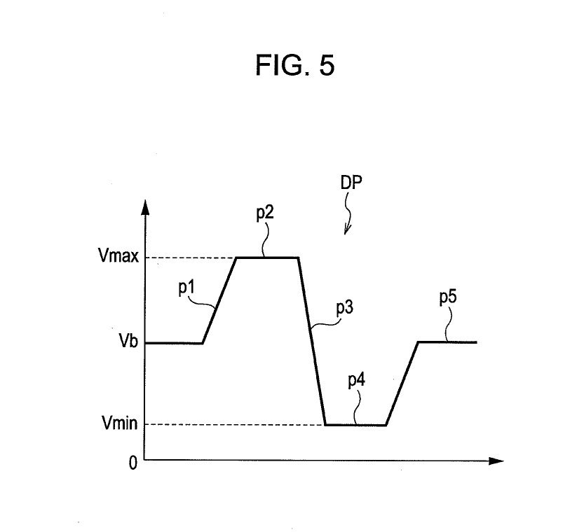

FIG. 3 is a longitudinal cross-sectional view illustrating the configuration of the vibrator unit 16. As shown in the figure, the piezoelectric vibrator 20 is a stacking type of piezoelectric vibrator formed by alternately stacking common internal electrodes 39 and individual internal electrodes 40 with piezoelectric bodies 41 therebetween. The common internal electrodes 39 are common electrodes for the entire piezoelectric vibrator 20 and set at ground potential. Further, the individual internal electrodes 40 are electrodes that change in potential in accordance with an ejection pulse DP (see FIG. 5) of an applied driving signal. In the embodiment, the portion from the vibrator front end of the piezoelectric vibrator 20 to the halfway or approximately the 2/3 portion in the vibrator-longitudinal direction (perpendicular to the stacking direction) is a free end portion 20a. Further, the remaining portion of the piezoelectric vibrator 20, that is, the portion from the base end of the free end portion 20a to the vibrator base end is a base end portion 20b.

An active region (overlap) A where the common internal electrodes 39 and the individual internal electrodes 40 overlap is formed at the free end portion 20a. When a potential difference is given to the internal electrodes 39 and 40, the piezoelectric bodies 41 in the active region operate and deform and the free end portion 20a extends/contracts in the vibrator-longitudinal direction. The base ends of the common internal electrodes 39 are connected to a common external electrode 42 on the base end surface of the piezoelectric vibrator 20. Meanwhile, the front ends of the individual internal electrodes 40 are connected to an individual external electrode 43 on the front end surface of the piezoelectric vibrator 20. Further, the front ends of the common internal electrodes 39 are positioned slightly ahead of the front end surface of the piezoelectric vibrator 20 (to the base end surface), while the base ends of the individual internal electrodes 40 are positioned at the interface between the free end portion 20a and the base end portion 20b.

The individual external electrode 43 (corresponding to the driving electrode in the invention) is an electrode formed in series at the front end surface of the piezoelectric vibrator 20 and a wire contact surface (upper surface in FIG. 3) that is a side in the stacking direction of the piezoelectric vibrator 20, and connects a wiring pattern of the flexible cable 22, which is a wire member, with the individual internal electrodes 40. The portion at the wire contact surface side of the individual external electrode 43 is continuously formed toward the front end side on the base end portion 20b. The common external electrode 42 is an electrode formed in series at the base end surface of the piezoelectric vibrator 20, the wire contact surface, and a fixing plate-attached surface (lower surface in FIG. 3) which is the opposite surface in the stacking direction of the piezoelectric vibrator 20, and connects the wiring pattern of the flexible cable 22 with the common internal electrodes 39. The portion at the wire contact surface side of the common external electrode 42 is continuously formed slight ahead of the end portion of the individual external electrode 43 toward the base end surface side and the portion at the fixing plate-attached surface is continuously formed slightly ahead of the front end surface of the vibrator toward the base end side.

The base end portion 20b is a non-operating portion that does not extend/contract even if the piezoelectric bodies 41 in the active region A operate. A flexible cable 18 is disposed on the wire contact surface of the base end portion 20b, such that the individual external electrode 43 and the common external electrode 42 and the flexible cable 22 are electrically connected, above the base end portion 20b. Accordingly, a driving signal is supplied to the individual external electrode 43 through the flexible cable 22.

The channel unit 17 is formed by bonding a nozzle plate 24 to a surface of a channel forming base plate 23 and bonding a vibration plate 25 to the other surface of the channel forming base plate 23. A reservoir 26 (common liquid chamber), an ink supply hole 27, a pressure chamber 28, a nozzle connection hole 29, and nozzles 30 are disposed in the channel unit 17. Accordingly, a series of ink channel is formed from the ink supply hole 27 to the nozzles 30 through the pressure chamber 28 and the nozzle connection hole 29, corresponding to the nozzles 30, respectively.

The nozzle plate 24 is a thin plate made of metal, such as stainless steel, having a plurality of nozzles 30 bored at a pitch corresponding to dot formation density (for example, 180 dpi) in a line. The nozzles 30 are disposed in lines and a plurality of nozzle lines (nozzle groups) is disposed on the nozzle plate 24, and for example, one nozzle line is composed of 180 nozzles 30. The surface where ink is ejected from the nozzles 30 of the nozzle plate 24 corresponds to the nozzle formation surface in the invention.

The vibration plate 25 has a double structure where an elastic layer 32 is stacked on the surface of a support plate 31. In the embodiment, the vibration plate 25 is a composite plate member manufactured by using a stainless steel plate, which is a kind of metal plate, as the support plate 31 and laminating a resin film on the support plate 31 as the elastic film 32. A diaphragm portion 33 changing the area of the pressure chamber 28 is disposed on the vibration plate 25. Further, a compliance portion 34 sealing a portion f the reservoir 26 is disposed on the vibration plate 25.

The diaphragm portion 33 is manufactured by partially removing the support plate 31 by etching or the like. That is, the diaphragm portion 33 is composed of an island portion 35 where the front end surface of the free end portion 20a of the piezoelectric vibrator 20 is bonded, and a thin elastic portion 36 surrounding the island portion 35. The compliance portion 34 is manufactured by removing the support plate 31 in the region opposite the open surface of the reservoir 26 by etching or the like, similar to the diaphragm portion 33, and has a function as a damper absorbing a pressure change in liquid stored in the reservoir 26.

Accordingly, since the front end surface of the piezoelectric vibrator 20 is bonded to the island portion 35, it is possible to change the volume of the pressure chamber 28 by extending/contracting the free end portion 20a of the piezoelectric vibrator 20. A pressure change in the ink in the pressure chamber 28 is caused by the change in volume. Accordingly, the recording head 2 ejects the ink from the nozzles 30 by using the pressure change.

The cover member 45 is a member protecting the sides of the channel unit 17 and the sides of the head case 41 and manufactured by a plate member having electrical conductivity, such as stainless steel. In the embodiment, a portion of the cover member 45 is in contact with the edge of the nozzle formation surface, with the nozzles 30 of the nozzle plate 24 exposed, and is electrically connected to the nozzle plate 24. The cover member 45 is grounded and connected in contact to the nozzle plate 24 in order to prevent a driving IC from being damaged or the nozzle plate 24 from being charged, for example, due to static electricity generated from the recording paper 6 and transmitted through the nozzle plate 24.

Next, the electrical configuration of the printer 1 is described.

FIG. 4 is a block diagram illustrating the electrical configuration of the printer 1. An external device 50 is an electronic device that handles an image, such as a computer or a digital camera. The external device 50 is connected with the printer 1 such that communication is allowable, and transmits print data according to an image or the like to the printer 1 to print an image of a text on a recording medium, such as recording paper, in the printer 1.

The printer 1 of the embodiment includes a transport mechanism 8, a carriage moving mechanism 7, a linear encoder 10, a recording head 2, and a printer controller 51.

The printer controller 51 is a control unit for controlling the parts of the printer. The printer controller 51 includes an interface (I/F) unit 54, a CPU 55, a memory unit 56, a driving signal generating unit 57, and a platen application voltage generating unit 58. The interface unit 54 transmits/receives state data of the printer, including sending print data or a print instruction to the printer 1 from the external device 50 or receiving the state information of the printer 1 with the external device 50. The CPU 55 is a calculation processing unit for controlling the entire printer. The memory unit 56 is an element storing data that is used for programs or various controls of the CPU 55 and includes a ROM, a RAM, and NVRAM (Nonvolatile Memory Element). The CPU 55 controls the units in accordance with the programs stored in the memory unit 56.

The CPU 55 functions as a timing pulse generating unit that generates a timing pulse PTS from an encoder pulse EP output from the linear encoder 10. Accordingly, the CPU 55 controls transmission of print data in synchronization with the timing pulse PTS or generation of a driving signal COM by the driving signal generating unit 57. Further, the CPU 55 generates a timing signal, such as a latch signal LAT on the basis of the timing pulse PTS and outputs the timing signal to a head control unit 53 of the recording head 2. The head control unit 53 controls the supply of an ejection pulse DP (see FIG. 5) of the driving signal COM for the piezoelectric vibrator 20 of the recording head 2 on the basis of a head control signal (print data and timing signal) from the printer controller 51.

The platen application voltage generating unit 58 (corresponding to an electric field forming unit in the invention) functions as a power source generating a voltage that is applied to the platen 5. In the embodiment, the platen 5 is positively charged, that is, the piezoelectric vibrator 20 is charged with the same polarity as that of the individual external electrode 43, by applying a voltage having the same polarity as that of the driving signal to the platen 5. As described above, since the nozzle plate 24 is grounded, an electric field according to the voltage applied to the platen 5 and the distance (PG1 and PG2 described below) between the platen 5 (support protrusions 14 and main body 13) and the nozzle plate 24 is formed between the platen 5 and the nozzle plate 24. This is described in detail below.

The driving signal generating unit 57 generates an analog voltage signal on the basis of the waveform data relating to the waveform of the driving signal. Further, the driving signal generating unit 57 generates a driving signal COM by amplifying the voltage signal. The driving signal COM is supplied to the piezoelectric vibrator 20 that is a pressure generating unit of the recording head 2 when printing is performed on the recording medium (during recording or ejecting), and is a series of signals including at least one or more of ejecting-driving pulses DP shown in FIG. 5, for example, within a unit period that is a repeated period. The ejection pulse DP makes the piezoelectric vibrator 20 perform a predetermined operation to eject liquid-state ink from the nozzles 30 of the recording head 2.

FIG. 5 is a waveform diagram showing an example of the configuration of the ejection pulse DP included in the driving signal COM. The vertical axis indicates potential and the horizontal axis indicates time in FIG. 5. Further, the ejection pulse DP includes an expansion factor p1 for expanding the pressure chamber 28 by changing the potential of the positive side from standard potential (intermediate potential) Vb to the maximum potential (maximum voltage) Vmax, an expansion-maintaining factor p2 for maintaining the maximum potential Vmax for a predetermined time, a contraction factor p3 for rapidly contracting the pressure chamber 28 by changing the potential at the negative side from the maximum potential Vmax to the minimum potential (minimum voltage) Vmin, a contraction-maintaining (damping-holding) factor p4 for maintaining the minimum potential Vmin for a predetermined time, and a restoring factor p5 for restoring the potential from the minimum potential Vmin to the standard potential Vb.

The following operations are generated, when the ejection pulse DP is applied to the piezoelectric vibrator 20. First, as the piezoelectric vibrator 20 is contracted by the expansion factor p1, the pressure chamber 28 expands to the maximum volume corresponding to the maximum potential Vmax from the standard volume corresponding to the standard potential Vb. Accordingly, a meniscus exposed to the nozzles 30 is attracted to the pressure chamber. The expansion of the pressure chamber 28 is kept in the application period of the expansion-maintaining factor p2. When the contraction factor p3 is applied to the piezoelectric vibrator 20, following the expansion-maintaining factor p2, the piezoelectric vibrator 20 extends and the pressure chamber 28 correspondingly rapidly contracts from the maximum volume to the minimum volume corresponding to the minimum potential Vmin. The ink in the pressure chamber 28 is pressurized by the rapid contraction of the pressure chamber 28, such that several pl to several tens of pl of ink is ejected from the nozzles 30. The contraction of the pressure chamber 28 is maintained for a short time in the application period of the contraction-maintaining factor p4, and then the restoring factor p5 is applied to the piezoelectric vibrator 20, such that the pressure chamber 28 is restored to the standard volume corresponding to the standard potential Vb from the volume corresponding to the minimum potential Vmin.

In the printer 1 of the embodiment, since the platen 5 is charged with the same polarity as that of the individual external electrode 43, when the piezoelectric vibrator 20 is driven, by applying a voltage to the platen 5 by using the platen application voltage generating unit 58, the ink ejected from the nozzles 30 of the recording head 2 is not variably charged.

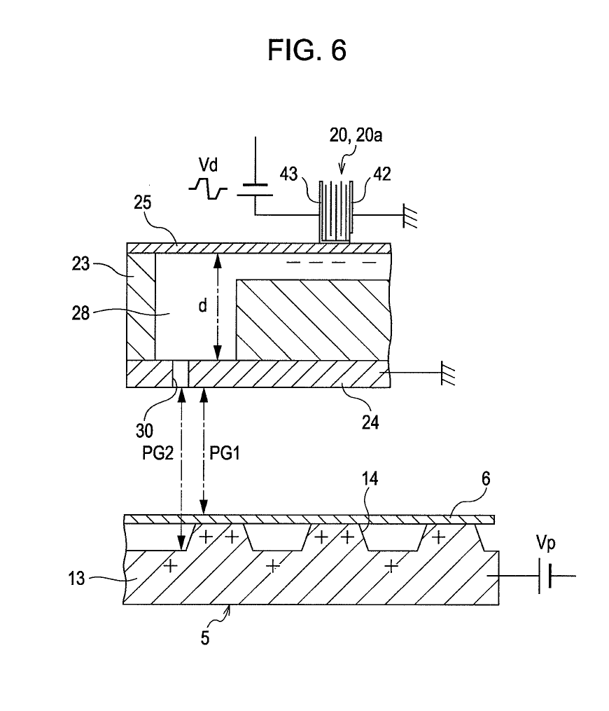

FIG. 6 is a schematic view illustrating uncharging of ink when the ink is ejected.

As described above, since the nozzle plate 24 is grounded through the cover member 45, a potential difference and an electric field (hereafter, platen-side electric field) are generated between the platen 5 and the nozzle plate 24 (nozzle formation surface) by positively charging the platen 5. The direction of the electric field is different from (opposite to) the direction of the electric field (hereafter, in-head electric field) generated between the nozzles 30 and the individual external electrode 43 of the piezoelectric vibrator 20 when ink is ejected from the nozzles 30. When the distance between the individual external electrode 43 of the piezoelectric vibrator 20 and the nozzle 30 is d, the distance from the nozzles 30 to the tops of the support protrusions 14 of the platen 5 is PG1, the distance from the nozzles 30 to the top of the main body 13 of the platen 5 is PG2, and the voltage applied to the platen 5 is Vp, the maximum intensity of the in-head electric field E_PZTmax is expressed as E_PZTmax=Vmax/d. Further, when the intensity of the electric field (hereafter, first platen electric field) E_PG1 generated between the support protrusions 14 and the nozzle plate 24 is expressed as E_PG1=Vp/PG1 and the intensity of the electric field (hereafter, second platen electric field) E_PG2 generated between the main body 13 and the nozzle plate 24 is expressed as E_PG2=Vp/PG2. Further, the recording paper 6 shows conductivity in accordance with the kinds, and in this case, it is preferable that the distance from the nozzle formation surface to the recording surface of the recording paper 6 be made PG1, but generally, the thickness of the recording paper 6 is smaller than the difference between PG1 and PG2, such that the distance from the nozzles 30 to the tops of the support protrusions 14 of the platen 5 is made PG1 in the embodiment, including the case.

In the embodiment, since a plurality of support protrusions 14 protrude in the main scanning direction on the top of the main body 13 of the platen 5 and the recording head 2 (carriage 4) ejects ink onto the recording paper 6 on the platen 5 while moving in the main scanning direction during printing, strictly, the intensity of the platen side electric field is different when the nozzles 30 of the recording head 2 are opposite the support protrusions 14 and when the nozzles 30 are opposite the other portion except for the support protrusions 14 of the main body 13 (E_PG1≠E_PG2). However, the intensity of the platen side electric field is averaged at a practical movement speed of the recording head 2 during recording. Therefore, when the average (E_PGavg) of the intensity of the platen side electric field becomes the same as the average (E_PZTavg) of the intensity of the in-head electric field when ink is ejected (ideally, E_PZTavg=E_PGavg), the induced charges of the ink around the nozzles 30 by both electric fields are offset. In order to satisfy the conditions, it is necessary for at least the intensity E_PZT of the in-head electric field to be between the intensity E_PG1 of the first electric field and the intensity E_PG2 of the second platen electric field, that is, to satisfy the following Formula (1).

E_{—}PG2<E_{—}PZT<E_{—}PG1 (1)

Further, in the embodiment, for the intensity of the in-head electric field E_PZT, the voltage applied to the individual external electrode 43 when the ink is ejected from the nozzles 30 is Vmax, such that the maximum intensity of the electric field E_PZTmax in this case is employed.

In the printer 1 of the invention, the applied voltage for the platen 5 is set to satisfy Formula (1). Therefore, an electric field that offsets the electric field between the individual external electrode 43 and the nozzles 30 when ink is ejected is generated between the platen 5 and the nozzle formation surface of the recording head 2.

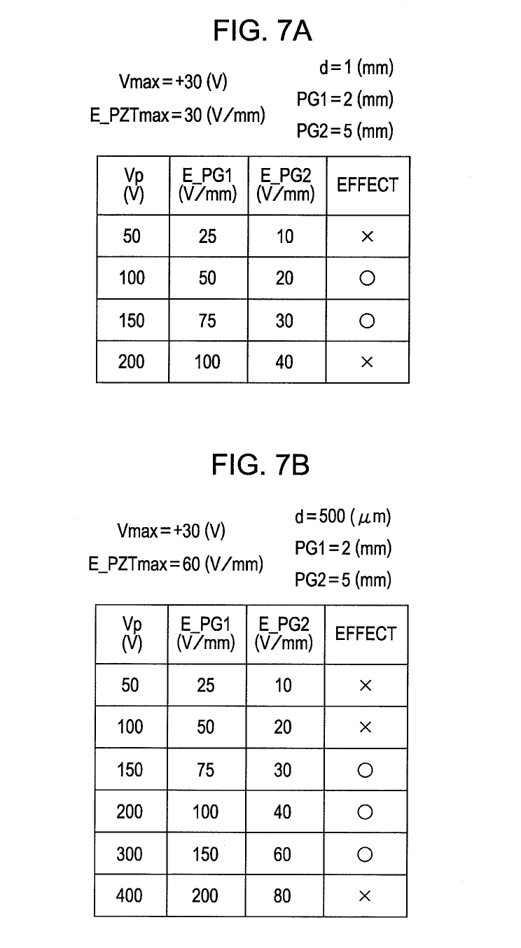

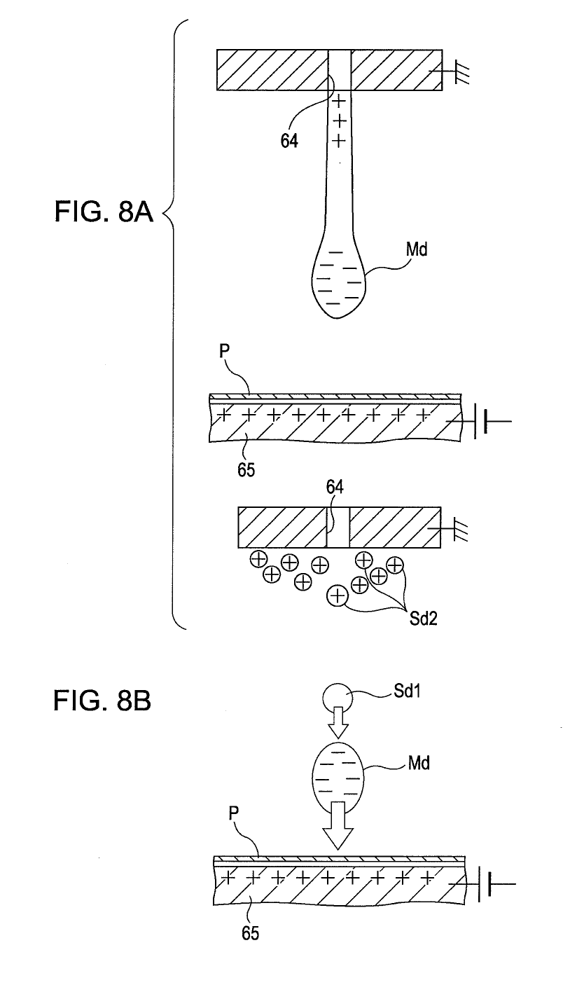

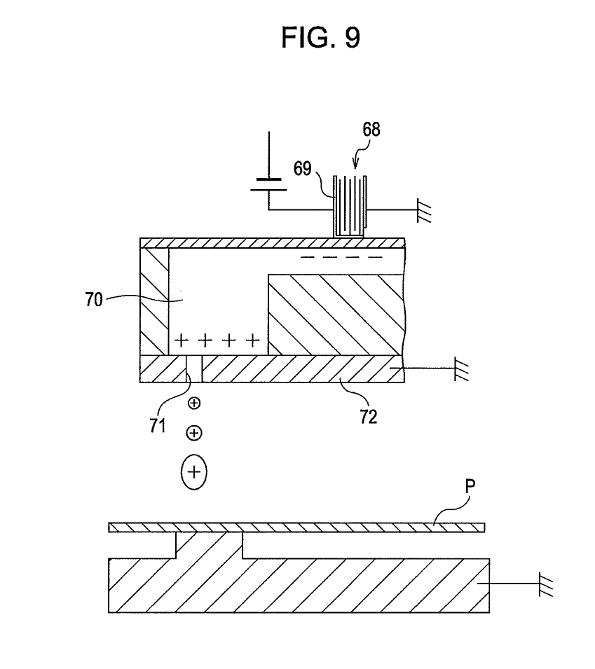

FIGS. 7A and 7B are tables showing the relationship between a platen application voltage Vp and a mist anti-charging effect. FIG. 7A shows experiment results for Vmax=30 (V), d=1 (mm), E_PZTmax=30 (V/mm), PG1=2 (mm), and PG2=5 (mm). For example, when the platen application voltage Vp was set at 50 (V), E_PG1=50/2=25 (V/mm) and E_PG2=50/5=10 (V/mm). In this case, Formula (1) was not satisfied and an anti-charging effect of mist could not be achieved (x). Similarly, even when the platen application voltage Vp was set at 200 (V), E_PG1=100 (V/mm) and E_PG2=40 (V/mm), such that Formula (1) was not satisfied and an anti-charging effect of mist could not be achieved (x). On the other hand, when the platen application voltage Vp was set at 100 (V), E_PG1=50 (V/mm) and E_PG2=20 (V/mm), such that Formula (1) was satisfied and an anti-charging effect of mist could be achieved (O). Similarly, when the platen application voltage Vp was set at 150 (V), E_PG1=75 (V/mm) and E_PG2=30 (V/mm), such that Formula (1) was satisfied and an anti-charging effect of mist could be achieved (O).

FIG. 7B shows experiment results for Vmax=30 (V), d=500 (gm), E_PZTmax=60 (V/mm), PG1=2 (mm), and PG2=5 (mm). For example, when the platen application voltage Vp is set at 100 (V), E_PG1=50 (V/mm) and E_PG2=20 (V/mm). In this case, Formula (1) was not satisfied and an anti-charging effect of mist could not be achieved (x). Similarly, when the platen application voltage Vp was set at 50 (V) and even when the platen application voltage Vp was set at 400 (V), Formula (1) was not satisfied and an anti-charging effect of mist could not be achieved (x). On the other hand, when the platen application voltage Vp was set at 150 (V), E_PG1=75 (V/mm) and E_PG2=30 (V/mm), such that Formula (1) was satisfied and an anti-charging effect of mist could be achieved (O). Similarly, when the platen application voltage Vp was set at 200 (V) and even when the platen application voltage Vp was set at 300 (V), Formula (1) was satisfied and an anti-charging effect of mist could be achieved (O).

By using the configuration described above, the charges induced around the nozzles 30 are offset when ink is ejected and the ink ejected from the nozzles 30 is suppressed from being charged. As described above, even if the ink is separated while scattering toward the recording medium, such as the recording paper 6, and satellite droplets or mist smaller than the satellite droplets are generated, the mist is suppressed from being charged, by preventing the ink ejected from the nozzles 30 from charged as much as possible, such that the mist less adheres to the components (easily chargeable components, such as the driving motor, the driving belt, and the linear scale). As a result, a breakdown due to the adhering mist is prevented and durability and reliability of the printer 1 are improved. Further, according to the configuration, not limited to the exemplified metal product, it is possible to achieve the effect to suppress the ink ejected from the nozzles 30 from being charged, even if the nozzle plate 24 is implemented by a monocrystal silicon substrate or a non-conductive material, such as a resin plate.

Further, when the charged polarity of the ink ejected from the nozzles 30 while the recording head 2 moves is observed in time series, when the average E_PGavg of the platen side electric field intensity satisfies E_PG2<E_PGavg<E_PG1, the charged polarity of the ink droplets ejected from the nozzles 30 is different when the nozzles 30 are opposite the support protrusions 14 and when the nozzles 30 are opposite the other portion except for the support protrusions 14 of the main body 13. However, where there is mist with different polarities, the mist is bonded by an electrostatic force, such that charges are neutralized. Therefore, the mist is consequently suppressed from being charged, even though the ink ejected from the nozzles 30 is not necessarily non-charged, such that the mist or the like is prevented from adhering to the components (for example, easily chargeable components, such as the driving motor, the driving belt, and the linear scale) in the printer.

However, the invention is not limited to the embodiment described above and may be modified in various ways on the basis of the aspects described in claims.

For example, although the embodiments exemplify the so-called longitudinal vibration type of piezoelectric vibrator 20 as a pressure generating unit, the invention is not limited thereto and may use a so-called flexural vibration type of piezoelectric vibrator. In this case, as shown in FIG. 5, the waveform of the driving signal (ejection pulse DP) becomes a waveform with the direction of potential changed, that is, an upside-down waveform. Further, a configuration using a pressure generating unit driven by receiving a voltage, such as a heater element generating a pressure change by bumping ink by generating heat or an electrostatic actuator generating a pressure change by moving a separation wall of a pressure chamber by using an electrostatic force, may also be applied to the invention.

Further, as long as it is a liquid ejecting apparatus that can control ejection of liquid by using a pressure generating unit, the invention is not limited to a printer and may also be applied to a variety of ink jet type of recording apparatuses, such as a plotter, a facsimile, and a copy machine, or a liquid ejecting apparatus other than the recording apparatuses, such as a display manufacturing apparatus, an electrode manufacturing apparatus, and a chip manufacturing apparatus. Accordingly, in the display manufacturing apparatus, liquid having color materials of R (Red), G (Green), and B (Blue) is ejected from a color material ejecting head. Further, in the electrode manufacturing apparatus, a liquid-state electrode material is ejected from an electrode material ejecting head. In the chip manufacturing apparatus, liquid of a bioorganic material is ejected from a bioorganic material ejecting head.

The entire disclosure of Japanese Patent Application No. 2011-044587, filed Mar. 2, 2011 is expressly incorporated by reference herein.

What is claimed is:

1. A liquid ejecting apparatus comprising:
a liquid ejecting head that has a nozzle formation surface where nozzles ejecting liquid are formed and a pressure generating unit driven by a driving signal and generating a pressure change in a liquid in a pressure chamber communicating with the nozzles, and ejects the liquid toward a landing target from the nozzle by driving the pressure generating unit;
a driving signal generating unit that generates the driving signal for driving the pressure generating unit;
a support unit that is disposed with a gap from the nozzle formation surface of the liquid ejecting head and supports the landing target in ejecting; and
an electric field generating unit that generates an electric field between the nozzle formation surface and the support unit by applying a voltage having the same polarity as the polarity of the driving signal to the support unit,
wherein the support unit has a main body having a surface opposite the nozzle formation surface of the liquid ejecting head when the ejection is performed and a plurality of support portions protruding on the surface, and
the applied voltage for the support unit is set such that the intensity of an electric field generated between a driving electrode and the nozzles when the liquid is ejected from the nozzles is in between the intensity of an electric field generated between the nozzle formation surface and the support portions and the intensity of an electric field generated between the nozzle formation surface and the main body.
